(19) United States
(12) Patent Application Publication
(10) Pub. No.: US 2012/0110918 A1
(43) Pub. Date: May 10, 2012

(54) FASTENING ARRANGEMENT FOR MOUNTING A DECORATIVE PANEL

(75) Inventor: Alistair LOVE, Kriftel (DE)

(73) Assignee: GM GLOBAL TECHNOLOGY OPERATIONS LLC, Detroit, MI (US)

(21) Appl. No.: 13/293,192

(22) Filed: Nov. 10, 2011

(30) Foreign Application Priority Data
Nov. 10, 2010 (DE) 102010050959.0

(51) Int. Cl. F16B 5/12; B60J 1/08; B60J 5/04

(52) U.S. Cl. 49/502; 24/292

(57) ABSTRACT

A fastening arrangement is provided for mounting a decorative panel on a vehicle door that includes, but is not limited to a frame profile forming an opening for a side window of the vehicle door, on which the decorative panel for covering the profile is mounted with a fastener. The fastener includes, but is not limited to an elongate fastening piece passing through an opening in the frame profile and a fastening counterpiece connected to the fastening piece. The fastening counterpiece is connected to the decorative panel. The elongate fastening piece extends perpendicular to a door plane and can be connected to the fastening counterpiece from a door inner side.

### CROSS-REFERENCE TO RELATED APPLICATION

This application claims priority to German Patent Application No. 102010050959.0, filed Nov. 10, 2010, which is incorporated herein by reference in its entirety.

### TECHNICAL FIELD

The technical field relates to the field of automotive engineering and relates to a fastening arrangement for mounting a decorative panel on a vehicle door.

### BACKGROUND

Vehicle doors built into motor vehicles typically have a frame profile by which means an opening for a vertically displaceable side window is formed. In this case, it is usual to attach a decorative panel to the frame profile, which covers a profile section of the frame profile extending along a supporting pillar, in particular the central pillar, of the vehicle body.

FIG. 3 illustrates a conventional vehicle door 101, for example. Accordingly, the vehicle door 101 mounted on the vehicle body, which here for example comprises the front door on the driver's side of the motor vehicle, comprises a flat base section 102, having a frame profile 103 formed on the upper side thereof. The frame profile 103 describes an opening 104 for receiving a vertically displaceable side window (not shown). Pane guide channels, not shown in detail in FIG. 3, are provided for this purpose, which channels extend into the base part 102 and receive the lateral edges of the side window for the guidance thereof. The frame profile 103 is composed of a front vertical strut 105, a rear vertical strut 106, and an upper transverse strut 107 which interconnects the two vertical struts 105, 106. In the mounted state, the rear vertical strut 107 typically extends along a supporting pillar, in particular a central pillar (B pillar) of the vehicle body. A decorative panel 108, which is mounted on the outer side of the rear vertical strut 106, is provided for covering the frame profile 103 in the area of the central pillar.

As shown in detail in FIG. 4, the decorative panel 108 is usually fastened with a plurality of fastening means on the frame profile 103 from the door outer side. In this case, fastening screws 110 are screwed into corresponding screw nuts 111, which have been previously mounted on the rear vertical strut 106. Since the decorative panel 108 is provided with a pane guide 109 for the side window, mounting of the decorative panel 108 is difficult for the fitter since the position of application for the mounting tool is only barely accessible and the mounting tool must be guided past the pane guide 109. In view of the space requirement, it is favorable if the fastening screws 110 engage in a cavity 112 of the vertical strut 106 so that they are usually positioned obliquely to the door plane or obliquely to the vehicle longitudinal direction (x) depending on the design. As a consequence of this, only small mounting tolerances can be compensated since a displacement of the decorative panel 108 in the vehicle transverse direction (y) is always accompanied by a change in the vehicle longitudinal direction (x).

In view of the foregoing, it is at least one object to further develop fastening arrangements known in the prior art for the mounting of decorative panels on vehicle doors. In addition, other objects, desirable features and characteristics will become apparent from the subsequent summary and detailed description, and the appended claims, taken in conjunction with the accompanying drawings and this background.

### SUMMARY

The directional information provided hereinafter, “in the vehicle longitudinal direction”, “in the vehicle transverse direction”, and “in the vehicle vertical direction” relate to a vehicle door mounted on the vehicle body of a motor vehicle.

A fastening arrangement is provided for mounting a decorative panel on a vehicle door of a motor vehicle is provided. The fastening arrangement comprises a frame profile forming an opening for a side window of the vehicle door, on which the decorative panel for covering said profile is mounted by means of at least one fastener. In this case, the frame profile in particular comprises a profile section which is configured so that when the vehicle door is mounted, it extends along a supporting pillar defining a door opening, in particular a central pillar, of the motor vehicle body, where the decorative panel is advantageously fastened to this profile section.

The fastening means or fastening further comprises an elongate fastening piece passing through an opening in the frame profile and a fastening counterpiece connected to the fastening piece, where the fastening counterpiece is connected to the decorative panel. The elongate fastening piece extends perpendicular to a door plane or in the vehicle transverse direction. The fastening is configured so that the elongate fastener can be connected or is connected to the fastening counterpiece from a door inner side.

The fastening arrangement therefore advantageously enables a simplified mounting of the decorative panel on the frame profile since the fitter has simple access to the fastening means during the mounting process. In addition, mounting tolerances which occur when fastening the decorative panel in the door plane or in the vehicle longitudinal direction and perpendicular to the door plane or in the vehicle transverse direction in the vehicle vertical direction can simply be compensated since the mounting tolerances in the vehicle transverse direction are decoupled from the mounting tolerances in the vehicle longitudinal or the vehicle vertical direction.

In an embodiment of the fastening arrangement, the fastener is configured such that the elongate fastening piece can be displaced in at least a direction perpendicular thereto, in particular along a longitudinal and/or vertical direction of the vehicle door or in the vehicle longitudinal and/or vehicle vertical direction. The decorative panel can thus be placed simply and rapidly to achieve a suitable joining pattern.

In a further advantageous embodiment of the fastening arrangement, the decorative panel has a pane guide for receiving a lateral pane edge of the side window. This measure enables a constructively simple and space-saving connection of the pane guide to the frame profile. In addition, the overall assembly is simplified by the combined fastening of decorative panel and pane guide and the assembly time is reduced.

In a further embodiment of the fastening arrangement, the decorative panel is formed in one piece with the pane guide, for example, as a plastic cast part, which enables a particularly simple and cost-effective manufacture of decorative panel and pane guide.

In a further embodiment of the fastening arrangement, the fastening counterpiece is connected to the pane guide, where the fastening counterpiece can be disposed on a first wall of the pane guide disposed parallel to the door plane or in the vehicle longitudinal direction and/or on a second wall of the pane guide disposed perpendicular to the door plane or in the vehicle transverse direction. This enables a constructively particularly simple implementation of the fastening arrangement.

In a further embodiment of the fastening arrangement, the fastening counterpiece is disposed in an intermediate space between the pane guide and the frame profile, whereby the space requirement required for fastening the decorative panel is particularly small.

In a further embodiment of the fastening arrangement, the fastening counterpiece serves as a spacer for the decorative panel between the pane guide and the frame profile so that a particularly simple and precise mounting of the decorative panel is possible for the fitter.

In a further embodiment of the fastening arrangement, the frame profile and the pane guide are configured at least in an approximately fitting manner, where a particularly large field of view can be achieved for passengers in the passenger cabin of the automobile.

In a further embodiment of the fastening arrangement, the fastening counterpiece and the pane guide are configured in one piece, for example as a plastic cast part, where a particularly simple and inexpensive manufacture is possible.

In a further embodiment of the fastening arrangement, the frame profile comprises a flange for connection to the decorative panel so that the decorative panel can be fastened in a particularly simple manner.

The fastener can generally be configured in manifold ways, where fasting piece and fastening counterpiece can be interconnected in particular non-positively and/or positively, for example, by means of a screw connection, clamping, or a catch mechanism. Advantageously but not necessarily the fastening piece comprises a bolt provided with an external thread, which can be screwed to a screw nut provided with an internal thread. In this case, the fastening counterpiece can in particular comprise a housing having an elongate hole through which the fastening piece passes and an insertion part which is disposed in the housing and connected to the fastening piece. The elongate hole is, for example, oriented parallel to the door plane or in the vehicle longitudinal direction so that mounting tolerances in the vehicle longitudinal direction can be compensated in a simple manner independently of mounting tolerances in the vehicle transverse direction.

A vehicle door is also provided having a fastening arrangement described as above. A vehicle body and an automobile are also provided having at least one vehicle door

### BRIEF DESCRIPTION OF THE DRAWINGS

The present invention will hereinafter be described in conjunction with the following drawing figures, wherein like numerals denote like elements, and:

FIG. 1 shows a schematic perspective view of an exemplary embodiment of the fastening arrangement for fastening a decorative panel;

FIG. 2A-2B show perspective views of variants of the fastening arrangement from FIG. 1;

FIG. 3 shows a schematic perspective view of a conventional vehicle door; and

FIG. 4 shows a schematic perspective view of a conventional fastening arrangement for fastening a decorative panel on the frame profile of the vehicle door from FIG. 3.

### DETAILED DESCRIPTION

The following detailed description is merely exemplary in nature and is not intended to limit application and uses. Furthermore, there is no intention to be bound by any theory presented in the preceding background or summary or the following detailed description.

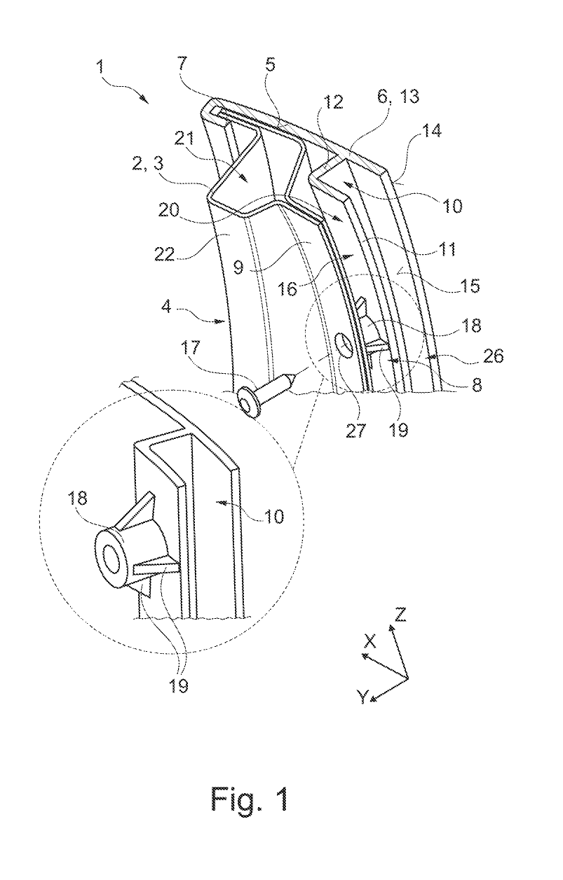

FIG. 1 is first considered, where a fastening arrangement, designated in general by the reference number 1, for mounting a decorative panel 6 on a frame profile 3 of a vehicle door 4 is illustrated with a schematic perspective view. In FIG. 1 the vehicle longitudinal direction (x) directed toward the rear or the tail end of the vehicle, the vehicle transverse direction (y), and the vehicle vertical direction (z) are indicated for the mounted state of the vehicle door 4 by means of their usual designations and directions in automotive engineering.

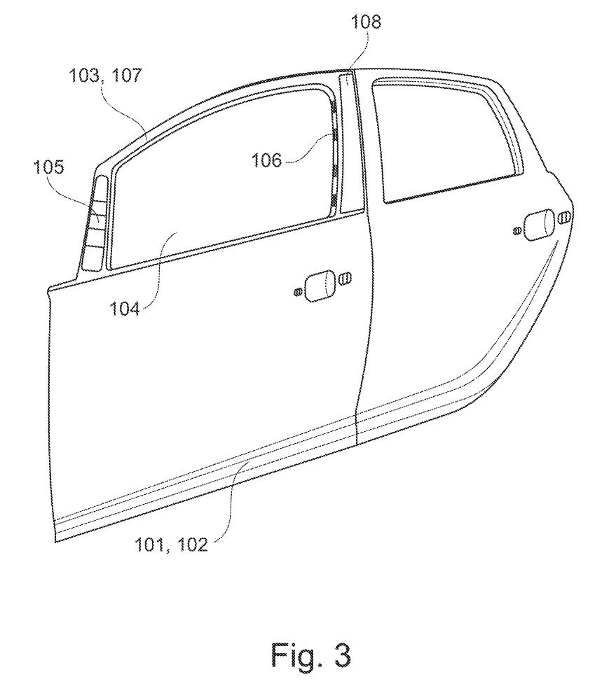

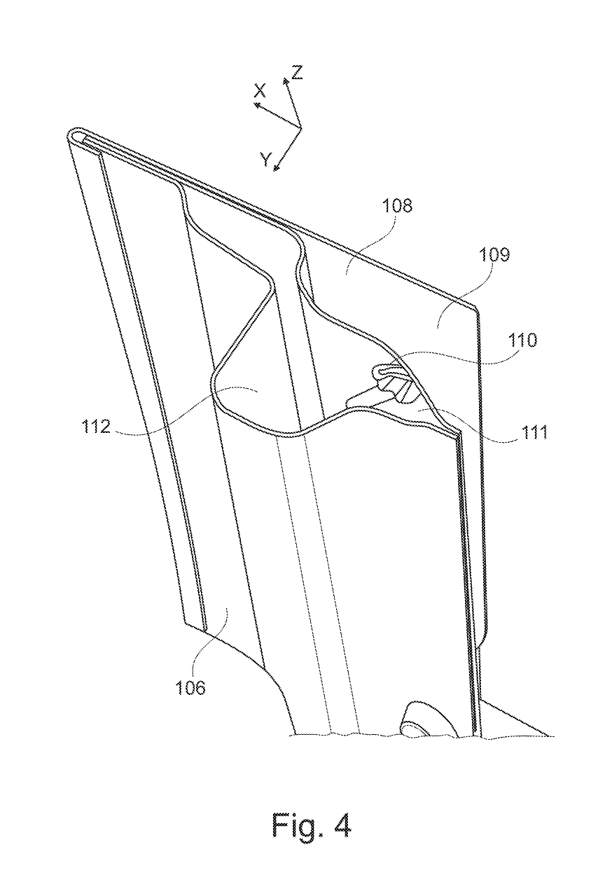

Accordingly, the fastening arrangement 1 comprises a vertical strut 2 running in the vehicle vertical direction (z), which comprises a profile section of the frame profile 3, which is merely shown as a cut-out in FIG. 1. The frame profile 3 in the usual manner forms an opening 26 for a vertically displaceable side window (not shown). As already explained initially in connection with FIG. 3 and FIG. 4, the vertical strut 2 can, for example, comprise the rear vertical strut of a front side door on the driver's or passenger's side, which in the mounted state extends along a supporting pillar, in particular central pillar (B pillar) of the automobile body. The decorative panel 6 extending similarly in the vehicle vertical direction (z) is attached to an outer side 5 of the vertical strut 2, which decorative panel covers vertical strut 2 toward the outside.

The decorative panel 6 can be divided at least conceptually into a plurality of panel sections. It thus comprises a panel wall 13 having an outer wall surface 14 and an inner wall surface 15. A corner angle 16 extending in the vehicle vertical direction (z) is formed on the inner wall surface 15 of the decorative panel 6, which jointly with the inner wall surface 15 of the panel wall 13 forms a channel-shaped pane guide 10 for receiving a lateral edge of the side window. A corresponding pane guide is formed on the opposite (front) vertical strut, not shown in FIG. 1, where the side window is guided by the two pane guides in the vertical direction in order to be able to open or close the side window. The corner angle 16 of the pane guide 10 is composed of a first channel wall 11 oriented in the door plane or vehicle longitudinal direction (x) and vehicle vertical direction (z) and a second channel wall 12 oriented transversely to the door plane or in the vehicle transverse direction (y) and vehicle vertical direction (z). In the present exemplary embodiment the decorative panel 6 is formed in one part or one piece from a plastic injection molded part.

The decorative panel 6 embraces a rear or back-side profile edge 7 of the vertical strut 2 and is connected by means of a plurality of fastening means 8 to a flange 9 of the vertical strut 2 disposed opposite to the profile edge 7. Only one fastening means 8 is shown in FIG. 1 for the purpose of a simpler representation. The fastening means 8 each comprise an elongated bolt 17 having an external thread which is screwed to a threaded nut 18 having a corresponding internal thread formed on the door inner-side outer side of the first channel wall 11. The cylindrical threaded nuts 18 are each provided with supporting wings 19 disposed in a distributed manner around the circumference for support against the first channel wall 12. In the present exemplary embodiment the threaded nuts 18 are formed in one part or one piece by casting with the decorative panel, which is cast, for example, from plastic. A metal internal thread is inserted into the threaded nuts 18.

The bolts 17 each pass through an opening 27 in the flange 9 and are screwed to the threaded nut 18, where the bolts 17 can extend transversely to the door plane or in the vehicle transverse direction (y) and be screwed from the door inner side. The opening 27 is shown here, for example, as a circular hole, although it can equally well be formed as an oblong hole. The opening 27 is formed in this case with a small oversize so that the decorative panel 6 can be displaced in the vehicle longitudinal direction (x) and/or in the vehicle vertical direction (z), in order to compensate for mounting tolerances. Likewise, mounting tolerances in the vehicle transverse direction (y) can be simply compensated, for example, by washers, where a particular advantage is obtained from the fact that compensation of mounting tolerances can take place in the vehicle transverse direction (y) independently of any compensation of mounting tolerances in the vehicle longitudinal direction (x) and/or the vehicle vertical direction (z). A particularly simple and controlled mounting of the decorative panel 6 from the door inner side is thus possible for the fitter where an attractive joining pattern can always be achieved in industrial series production. When placing the decorative panel 6 on the vertical struts 2 of the frame profile 3, the threaded nuts 18 serve as spacers so that the decorative panel 6 can be positioned particularly simply and precisely in the vehicle transverse direction (y). Due to their arrangement on the first channel wall 11, the threaded nuts 18 are located in an intermediate space 20 between the pane guide 10 and the vertical strut 2. As a result, the fastening arrangement 1 requires relatively little installation space. As is deduced similarly from FIG. 1, the vertical strut 2 is configured with a strut section 22 forming a cavity 21 at least approximately fitting to the corner angle 16. The vertical struts 2 can thus be made more compact overall, whereby the flange 9, compared with the conventional configuration of the vertical strut 105 shown in FIG. 4, is located in alignment with the pane guide 10 and is therefore located closer to the vehicle rear end so that a particularly large field of view can advantageously be achieved.

It is understood that instead of bolts 17 and threaded nuts 18, other fasteners 8 can also be provided for fastening the decorative panel 6 in the fastening arrangement 1, for example, plug, snap, or latching connections. Likewise, self-tapping screws, for example, can be used instead of the bolts 17.

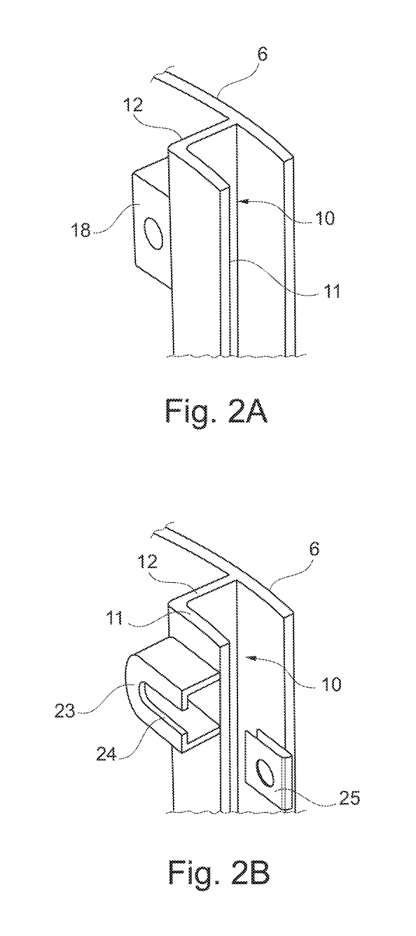

Reference is now made to FIG. 2A and FIG. 2B where variants of the fastening arrangement from FIG. 1 are shown. In order to avoid unnecessary repetitions, merely the differences from the fastening arrangement of FIG. 1 are explained here and otherwise reference is made to the statements made there. Accordingly, as shown in FIG. 2A, the threaded nuts 18 can equally well be formed on the outer side of the second channel wall 11, for example, in order to satisfy specific requirements or constructive specifications. As shown in FIG. 2B, instead of a threaded nut 18 a housing 23 formed on the first channel wall 11 having an oblong hole 24 extending, for example, in the vehicle longitudinal direction (x) can be provided here. The oblong hole 24 can have the bolt 17 passing through it and be screwed to a metal insertion part 25. Mounting tolerances in the vehicle longitudinal direction (x) can be compensated particularly simply by oblong hole 24, independently of compensation for mounting tolerances of the vehicle transverse direction (y).

A fastening arrangement for the mounting of a decorative panel on a frame profile of a vehicle door, which enables simple and cost-effective mounting in industrial series production, where independent compensation of mounting tolerances in the vehicle transverse direction (y) and vehicle longitudinal or vehicle vertical direction (x, z) is made possible.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A fastening arrangement for mounting a decorative panel on a vehicle door having a side window, comprising:
a fastener;
a frame profile forming an opening for the side window on which the decorative panel configured to cover the frame profile is mounted with the fastener;
an elongated fastening piece of the fastener configured to pass through a second opening in the frame profile; and
a fastening counterpiece connected to the elongated fastening piece, the fastening counterpiece is configured to connect to the decorative panel, and
wherein the elongated fastening piece extends substantially perpendicular to a door plane and can be connected to the fastening counterpiece from a door inner side.

2. The fastening arrangement according to claim 1, wherein the fastener is configured such that the elongated fastening piece is configured to displace in at least a direction perpendicular

3. The fastening arrangement according to claim 1, wherein the fastener is configured such that the elongated fastening piece is configured to displace along a longitudinal direction of the vehicle door.

4. The fastening arrangement according to claim 1, wherein the fastener is configured such that the elongated fastening piece is configured to displace along a vertical direction of the vehicle door.

5. The fastening arrangement according to claim 1, wherein the decorative panel comprises a pane guide configured to receive a lateral pane edge of the side window.

6. The fastening arrangement according to claim 5, wherein the decorative panel is formed in one piece with the pane guide.

7. The fastening arrangement according to claim 5, wherein the fastening counterpiece is connected to a wall forming the pane guide.

8. The fastening arrangement according to claim 7, wherein the fastening counterpiece is disposed on a first wall of the pane guide that is disposed substantially parallel to the door plane.

9. The fastening arrangement according to claim 8, wherein the fastening counterpiece is disposed in an intermediate space between the pane guide and the frame profile.

10. The fastening arrangement according to claim 9, wherein the fastening counterpiece is configured to serve as a spacer for the decorative panel between the pane guide and the frame profile.

11. The fastening arrangement according to claim 9, wherein the frame profile and the pane guide are configured in at least an approximately fitting manner.

12. The fastening arrangement according to claim 7, wherein the fastening counterpiece is disposed on a second wall of the pane guide disposed substantially perpendicular to the decorative panel.

13. The fastening arrangement according to claim 5, wherein the fastening counterpiece and the pane guide are configured in one piece.

14. The fastening arrangement according to claim 1, wherein the frame profile comprises a flange configured for connection to the decorative panel.

15. A vehicle door, comprising:
a decorative panel;
a side window;
a fastener;
a frame profile forming an opening for the side window on which the decorative panel configured to cover the frame profile is mounted with the fastener
an elongated fastening piece of the fastener configured to pass through a second opening in the frame profile; and
a fastening counterpiece connected to the elongated fastening piece, the fastening counterpiece is configured to connect to the decorative panel, and
wherein the elongated fastening piece extends substantially perpendicular to a door plane and can be connected to the fastening counterpiece from a door inner side.

16. The vehicle door according to claim 15, wherein the fastener is configured such that the elongated fastening piece is configured to displace in at least a direction perpendicular

17. The vehicle door according to claim 15, wherein the fastener is configured such that the elongated fastening piece is configured to displace along a longitudinal direction of the vehicle door.

18. The vehicle door according to claim 15, wherein the fastener is configured such that the elongated fastening piece is configured to displace along a vertical direction of the vehicle door.

19. The vehicle door according to claim 15, wherein the decorative panel comprises a pane guide configured to receive a lateral pane edge of the side window.

20. The vehicle door according to claim 19, wherein the decorative panel is formed in one piece with the pane guide.
